(19) United States
(12) Patent Application Publication
(10) Pub. No.: US 2013/0298524 A1
(43) Pub. Date: Nov. 14, 2013

(54) DEVICE FOR LINKING A FRONT FRAME TO A FAN CASING

(71) Applicant: AIRCELLE, Gonfreville L'Orcher (FR)

(72) Inventor: Loic LE BOULICAUT, Le Havre (FR)

(21) Appl. No.: 13/942,047

(22) Filed: Jul. 15, 2013

Related U.S. Application Data
(63) Continuation of application No. PCT/FR2012/050059, filed on Jan. 10, 2012.

(30) Foreign Application Priority Data
Jan. 14, 2011 (FR) 11/50296

(51) Int. Cl. F02K 1/68

(52) U.S. Cl. CPC F02K 1/68
USPC 60/226.2; 239/265.19

(57) ABSTRACT

The present disclosure relates to a device for linking a front frame of a thrust reverser to a fan casing, which includes a linking flange capable of engaging with a receiving part secured to the casing and an annular receiving part secured to the front frame. The linking flange is made up of two flange sectors, movably mounted around an axis, pivoting between an engaged position and an open position. In the engaged position, the flange engages with the annular receiving part of the fan casing and the annular receiving part of the front frame so as to connect them. In the open position, the flange is radially separated from the annular receiving part of the fan casing and the annular receiving part of the front frame.

### CROSS-REFERENCE TO RELATED APPLICATIONS

This application is a continuation of International Application No. PCT/FR2012/050059, filed on Jan. 10, 2012, which claims the benefit of FR 11/50296, filed on Jan. 14, 2011. The disclosures of the above applications are incorporated herein by reference.

### FIELD

The present disclosure relates to a device for linking a thrust reverser front frame to a fan casing or other junctions of the same type, and a nacelle incorporating such a device.

### BACKGROUND

The statements in this section merely provide background information related to the present disclosure and may not constitute prior art.

As is known in itself, an aircraft propulsion assembly traditionally comprises a turbojet engine housed inside a nacelle.

The nacelle generally has a tubular structure comprising an air intake upstream from the turbojet engine, a middle section designed to surround a fan of the turbojet engine and its casing, a downstream section designed to surround the combustion chamber of the turbojet engine and, if applicable, housing thrust reverser means. It may end with a jet nozzle, the outlet of which is situated downstream from the turbojet engine.

Modern-day nacelles are designed to house a dual flow turbojet engine capable of using the rotating fan blades to create a flow of hot air (also called primary flow) coming from the combustion chamber of the turbojet engine, and a flow of cold air (secondary flow) that circulates outside the turbojet engine through an annular passage, also called a tunnel, formed between a fairing of the turbojet engine and an inner wall of the nacelle. The two flows of air are discharged from the turbojet engine through the rear of the nacelle.

During landing of an airplane, the role of a thrust reverser is to improve the breaking capacity thereof by reorienting at least part of the thrust generated by the turbojet engine forward. In this phase, the reverser obstructs the cold flow tunnel and orients that flow toward the front of the nacelle, thereby generating a counterthrust that is added to the braking of the wheels of the airplane.

The means used to perform this reorientation of the cold flow vary depending on the type of reverser. However, in most cases, the structure of a reverser comprises moving cowls that can be moved between a deployed position, in which they open a passage in a nacelle that is designed for the deflected flow, on the one hand, and a retracted position in which they close that passage on the other hand. These cowls may perform a deflection function (reverser with pivoting doors) or simply serve to activate other deflection means.

In the case of a grid reverser, also known as a cascade reverser, the reorientation of the flow of air is done by cascade vanes, the cowl simply performing a sliding function aiming to expose or cover said vanes. Complementary blocking doors, also called flaps, activated by the sliding of the cowling, generally make it possible to close the tunnel downstream from the vanes so as to optimize the reorientation of the cold flow.

In order to support the moving reverser cowls and connect the downstream section to the rest of the nacelle, and in particular to the middle section by means of the fan casing, the downstream section comprises stationary elements, and in particular longitudinal beams connected upstream to a substantially annular assembly called the front frame, made up of one or more parts between said longitudinal beams, and designed to be fastened to the periphery of the downstream edge of the fan casing of the engine.

This front frame is connected to the fan casing by fastening means generally of the blade/groove type comprising a substantially annular flange, made up of one or more parts, secured to the front frame and cooperating with a J- or V-shaped slot. The fastening assembly is commonly referred to as a J-ring.

Such a device works for so-called C-duct or D-duct nacelles having half-cowls that open sideways during maintenance operations.

Such a connecting device is not suitable for nacelles wherein the rear part is capable of sliding during maintenance operations (so-called O or O-duct nacelles) toward the rear of the nacelle in a substantially longitudinal direction thereof.

In such a nacelle configuration, one or more areas of the downstream section should be provided to open sideways so as to be able to move the flange away from the grooves and release the front frame from the casing.

### SUMMARY

The present disclosure relates to a device for connecting a thrust reverser front frame to a fan casing, comprising: at least one linking flange; an annular part for receiving the linking flange and secured to the fan casing; an annular part for receiving the linking flange and secured to the front frame.

The linking flange is made from at least two flange sectors, each sector being movably mounted pivoting between an engaged position in which the flange engages with the annular receiving part of the fan casing and the annular receiving part of the front frame so as to connect them, and an open position in which the flange is radially separated from the annular receiving part of the fan casing and the annular receiving part of the front frame so as to allow the fan casing and the front frame to be separated longitudinally.

It should be noted that it is possible indifferently to provide that the sliding part is both a front frame and the thrust reverser fan casing.

Thus, by providing a flange mounted slightly radially pivoting so as to engage or release the front frame with respect to the fan casing, it is possible to preserve an opening of the downstream section of the nacelle in a longitudinal direction thereof.

Advantageously, the sector is mounted pivoting around a substantially longitudinal axis situated at one end of said flange sector.

Preferably, the sector is mounted pivotably by means of a wheel, said sector being attached to the wheel slightly off-centered with respect to the pivot axis. Thus, the pivoting fastening point of the flange sector is also separated from the annular receiving parts, which facilitates a complete release.

According to a first alternative form, the pivoting flange is mounted on the front frame.

According to a second alternative form, the pivoting flange is mounted on the fan casing.

Preferably, the movable flange sector is associated with at least one sliding guide element. The presence of the sliding guide element makes it possible to control the opening of the flange, which in particular makes it possible to motorize the opening and closing thereof.

According to one preferred form, the linking flange is connected to two substantially semi-peripheral sectors.

Advantageously, the sectors are connected by a sliding junction. The sliding junction may in particular be equipped with gripping means capable of keeping the flange in the locked position.

As another form, the sectors are pivotably mounted against at least one elastic return means tending to assist the pivoting of the sector toward its separated or engaged position. The elastic return means may be of the automatic mechanical type, such as a spring, for example, or of the actuator type, in particular such as a hydraulically or electrically actuated bolt, for example.

The present disclosure also relates to a propulsion assembly including a downstream section connected to a fan casing of the turbojet engine using at least one connecting device according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an overall view of a turbojet engine nacelle;

FIG. 2 is a partial longitudinal cross-sectional view of a connecting device according to the present disclosure between a fan casing and a front frame of a rear section of the nacelle of FIG. 1, the connecting device being in the engaged position;

FIG. 3 is an overall view of the connecting device of FIG. 2;

FIG. 4 is a view similar to FIG. 2, the connecting device being in the open position;

FIG. 5 is a view similar to FIG. 3, the connecting device being in the open position;

FIG. 6 is an enlarged partial view of one pivoting end of a flange of the connecting device according to the present disclosure in the closed position;

FIG. 7 is an enlarged partial view of a sliding junction between two linking flanges of the device according to the present disclosure in the closed position;

FIGS. 8 and 9 are similar to FIGS. 6 and 7, the connecting device being in the open position; and

FIGS. 10, 11, 12, 13 and 14 show alternative forms of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

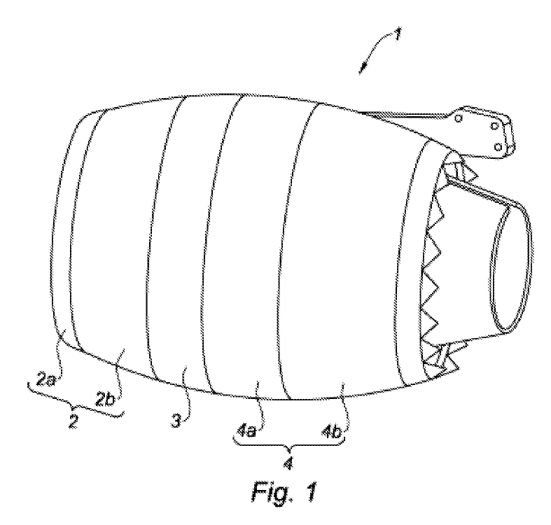

FIG. 1 is a diagrammatic illustration of a turbojet engine nacelle 1.

The nacelle 1 makes up a substantially tubular housing for the turbojet engine and generally comprises an upstream air intake section 2, a middle section 3 surrounding a fan of the turbojet engine, and a downstream section 4 surrounding a combustion chamber of the turbojet engine.

The upstream section 2 traditionally comprises an air intake lip structure 2a extended by a downstream air intake structure 2b.

The middle section 3 surrounds the fan and has an inner wall formed by a casing 3a of the fan.

The downstream section 4 may house a thrust reverser device 4b positioned in the extension of an upstream attachment section 4a to the rest of the nacelle, and in particular to the middle section 3. In the case of a smooth nacelle, there will only be one upstream attachment section 4a covering the entire downstream section 4.

As indicated in the preamble of the present disclosure, it is able to fasten the downstream section 4 to the middle section 3 strongly. As also explained, depending on the configuration of the nacelle, it is able to attach the downstream section 4 and the middle section 3 so that they can be disassembled, and in particular allowing opening by longitudinally translating the downstream section 4.

The downstream section 4 is attached to the middle section 3 using a front frame 40 of the downstream section 4 (and in particular providing support for the thrust reverser device 4b if applicable) having a substantially annular shape.

The attachment of the front frame 40 to the fan casing 3a is done using a connecting device according to the present disclosure.

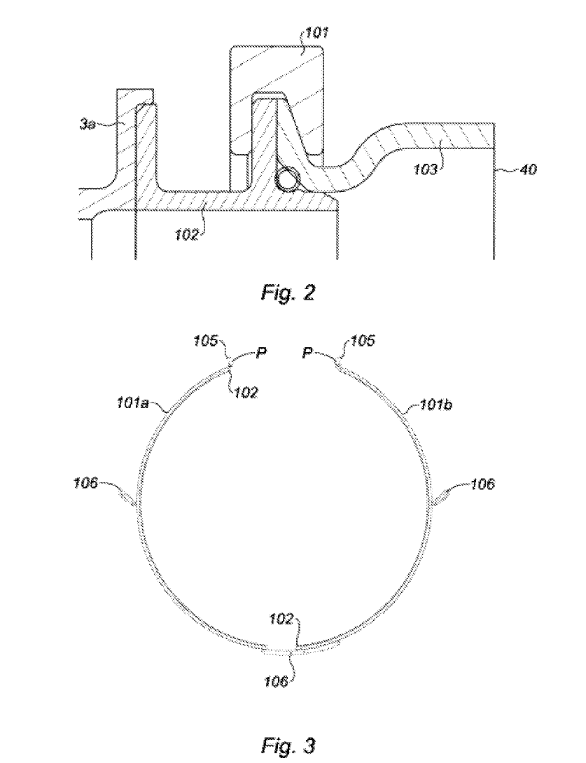

As shown in FIGS. 2 and 3, a connecting device according to the present disclosure comprises: a linking flange 101; an annular receiving part 102 receiving the linking flange and secured to the fan casing 3a (traditionally called “J-ring” due to its substantially J shape having an end return with which the flange 101 can engage); an annular receiving part 103 for receiving the linking flange and secured to the front frame 40 (also called “J-ring” for the same reasons).

It should be noted that the connection geometries are provided as an example and may vary depending on the forces exerted and security constraints: release, etc.

More specifically, as shown in FIG. 3, the annular receiving parts 102 and 103 are made in the form of substantially semi-peripheral annular parts so as to allow the placement of lower support beams, for example, and to allow the passage of an attachment pylon and support beams at 12 o'clock.

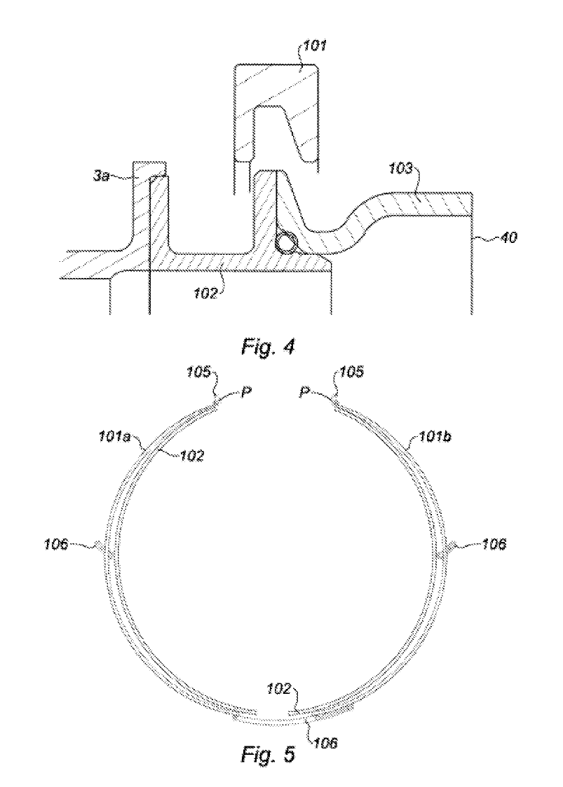

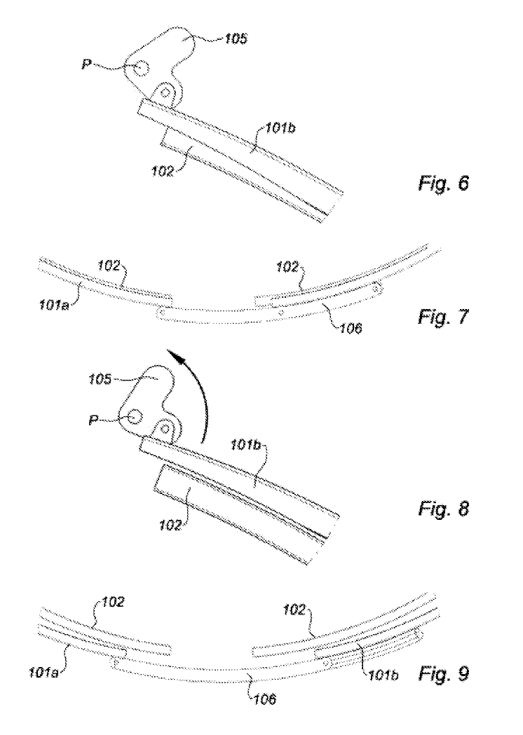

According to the present disclosure, the linking flange 101 is made from at least two flange sectors 101a, 101b, and each sector 101a, 101b is pivotably mounted between an engaged position (FIGS. 2 and 3), in which the flange 101 engages with the annular part 102 receiving the fan casing 3a and the annular part 103 receiving the front frame 40 so as to connect them, and an open position (FIGS. 4 and 5), in which the flange 101 is radially separated from the annular receiving part 102 of the fan casing 3a and the annular part 103 receiving the front frame 40 so as to allow longitudinal separation of the fan casing 3a and the front frame 40.

According to the illustrated example, the flange 101 comprises two substantially semi-peripheral flange sectors 101a, 101b.

According to the illustrated example, the flange sectors 101a, 101b are pivotably mounted around a substantially longitudinal axis P situated at an upper end of said flange sector 101a, 101b.

More specifically, the pivoting movement is done by means of a wheel 105, one end of the sector 101a, 101b being attached to the wheel slightly off-centered with respect to the pivot axis P, so as to ensure proper release of the flange 101.

The example shows a flange 101 mounted on the front frame 40. It is of course possible to provide for fastening the flange 101 on the casing 3a.

Complementarily, the flange sectors 101a, 101b are each associated with a sliding guide element 106.

Furthermore, the flange sectors 101a, 101b are advantageously connected by a sliding junction 106.

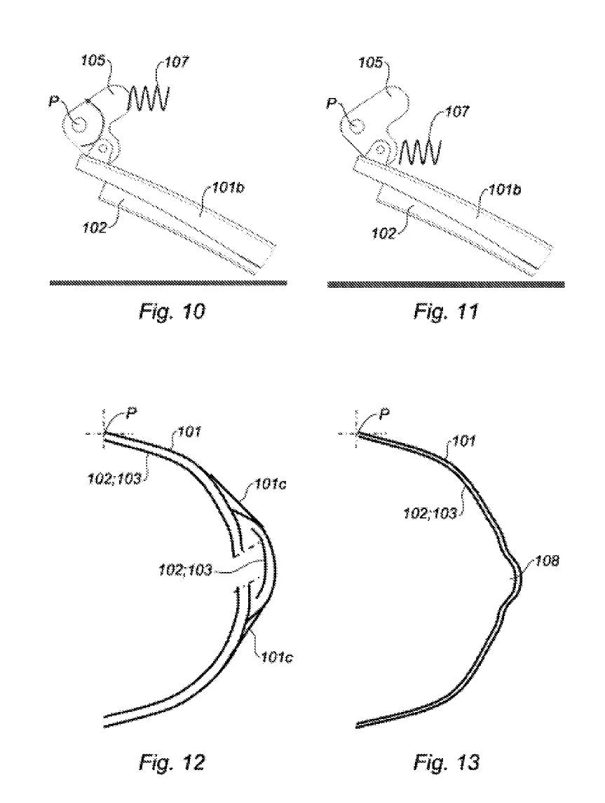

Also complementarily, as shown in FIGS. 10 and 11, the sectors 101a, 101b are pivotably mounted against at least one elastic return means tending to assist the pivoting of the sector toward its separated or engaged position. This elastic return means may be made in the form of springs 107 associated with the pivot wheel 105.

The sliding junction 106 may also be equipped with a system for tightening and maintaining in the closed position (bolt, wheel and worm screw, etc.) and may be unlocked manually or using motorized means. It should be noted that a system using a wheel and worm screw will allow sufficiently precise control of the opening kinematics of the flange such that the sliding guide elements 106 and the springs 107 are no longer useful.

It should also be noted that it is possible to produce shape irregularities in the flange sectors 101a, 101b so as for example to allow equipment to pass.

FIG. 12 shows a shape irregularity consisting of eliminating an area of the annular parts 102, 103 for the passage of said equipment. The eliminated area may be placed off board. Connectors 101c ensure the continuity of the flange 101.

FIG. 13 shows a second example of a shape irregularity consisting of forming a boss 108 in the flange 101 and the annular parts 102, 103. The shape of the boss 108 must of course allow the rotation of the flange 101.

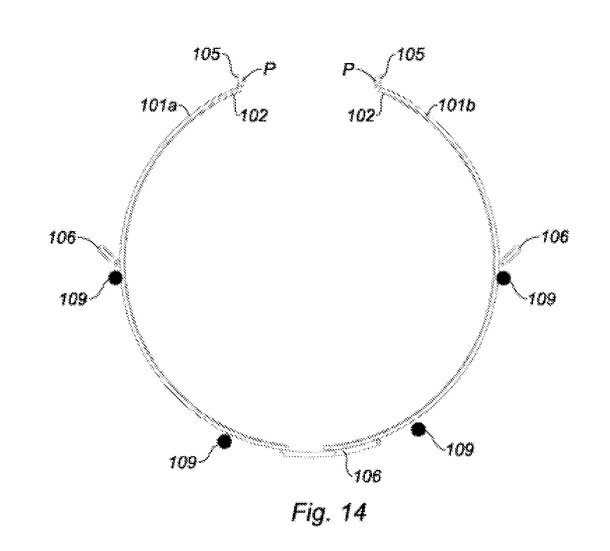

Complementarily, and as shown diagrammatically in FIG. 14, it is possible to provide stops 109, in particular of the ball-lock or bolt type, movable between an engaged position and a released position, said stops 109 making it possible to avoid disengagement of the flange 101 in the event the flange 101 breaks. With four stops 109 as illustrated, the disengagement in case of breakage is less than one quarter of the circumference of the flange 101.

It should also be noted that the system may be opened using a wheel and screw or bolt or any equivalent system.

Furthermore, the J-ring may have a non-circular shape depending on the peripheral shape of the junction.

Additionally, the connection may also be situated in an aerodynamic area, in which case an outer fairing should be added providing a good aerodynamic junction between the fairings of the upstream front frame part and the downstream part.

Although the present disclosure has been described with one particular example form, it is of course not limited thereto and encompasses all technical equivalents of the described means as well as combinations thereof if they are within the scope of the present disclosure.

What is claimed is:

1. A device for connecting a thrust reverser front frame to a fan casing, comprising:
at least one linking flange;
an annular part for receiving the linking flange and secured to the fan casing ;
an annular part for receiving the linking flange and secured to the front frame,
wherein the linking flange is made from at least two flange sectors, each sector being movably mounted around an axis by means of a wheel, being pivotably attached to the wheel slightly off-centered with respect to said axis, pivoting between an engaged position in which the flange engages with the annular receiving part of the fan casing and the annular receiving part of the front frame so as to connect them, and an open position in which the flange is radially separated from the annular receiving part of the fan casing and the annular receiving part of the front frame so as to allow the fan casing and the front frame to be separated longitudinally.

2. The device according to claim 1, wherein the axis is a substantially longitudinal axis situated at one end of said flange sector.

3. The device according to claim 1, wherein the linking flange is mounted on the front frame.

4. The device according to claim 1, wherein the linking flange is mounted on the fan casing.

5. The device according to claim 1, wherein the flange sector is associated with at least one sliding guide element.

6. The device according to claim 1, wherein the linking flange is connected to two substantially semi-peripheral sectors.

7. The device according to claim 1, wherein the flange sectors are connected by a sliding junction.

8. The device according to claim 1, wherein the flange sectors are pivotably mounted against at least one elastic return means to assist the pivoting of the flange sector toward its separated or engaged position.

9. A propulsion assembly comprising a turbojet engine housed inside a nacelle, said nacelle including a downstream section connected to a fan casing of the turbojet engine using at least one device according to claim 1.
